(19) United States
(12) Patent Application Publication
(10) Pub. No.: US 2006/0078473 A1
(43) Pub. Date: Apr. 13, 2006

(54) Ultrasonic platform type microchip and method of driving array-shaped ultrasonic transducers

(75) Inventor: Miyuki Murakami, Hino-shi (JP)

Correspondence Address: Scully, Scott, Murphy & Presser, 400 Garden City Plaza, Garden City, NY, 11530-3319, US

(73) Assignee: OLYMPUS CORPORATION, TOKYO (JP)

(21) Appl. No.: 11/274,659

(22) Filed: Nov. 15, 2005

Related U.S. Application Data
(63) Continuation of application No. PCT/JP04/06813, filed on May 13, 2004.

(30) Foreign Application Priority Data
May 16, 2003 (JP) 2003-139168
May 16, 2003 (JP) 2003-139170

(51) Int. Cl. B01L 3/00

(52) U.S. Cl. 422/100

(57) ABSTRACT

The present invention provides a micro chemical analysis system in which a flow type microchip configured to have a fine flow passage on a substrate is configured, the system comprising a common platform composed of a transducer layer and a signal control circuit layer, the transducer layer having array-shaped ultrasonic transducers. In addition, the flow type microchip is configured on the common platform.

### CROSS REFERENCE TO RELATED APPLICATIONS

This is a Continuation Application of PCT Application No. PCT/JP2004/006813, filed May 13, 2004, which was published under PCT Article 21(2) in Japanese.

This application is based upon and claims the benefit of priority from prior Japanese Patent Applications No. 2003-139168, filed May 16, 2003; and No. 2003-139170, filed May 16, 2003, the entire contents of both of which are incorporated herein by reference.

### BACKGROUND OF THE INVENTION

1. Field of the Invention

The present invention relates to a flow type microchip having a micro flow passage on a substrate. More particularly, the present invention relates to an ultrasonic platform type microchip wherein a flow type microchip having a flow passage according to its purpose formed thereon has been configured on a common platform which is composed of a transducer layer and a signal control layer, the transducer layer having array-shaped ultrasonic transducers, and a variety of functions are achieved with respect to a fluid by signal-controlling an arbitrary ultrasonic transducer, and a method of driving an ultrasonic transducer in the chip.

2. Description of the Related Art

In recent years, the fields of biotechnology, environmental technology, and information technology (IT) have focused attention as the fields of application of micro-electromechanical systems (MEMS) technology. As its specific application, research has been actively conducted worldwide, the research integrating functions required for chemical analysis or chemical synthesis by using a micro machining technique on a glass or a silicon substrate of some tens of millimeters in cube, and promoting downsizing of the chemical analysis or a synthetic system itself.

This research field is called micro total analysis systems (μTAS), and has a plenty of features as described below, as compared with a conventional analysis device for use in experimental room. That is, the features include: enabling achievement of a high speed analysis time; enabling downsizing or portability of an analysis device; enabling reduction of a solvent or a sample to be consumed; and enabling reduction of analysis cost. This research field is expected as a new technology for inexpensive analysis through high throughput on the site of medical applications or environment measurement. In particular, it is expected to downsize the smallest chemical system which has been of a table top size to a palm size by expanding it to a system having a sensor or an electronic circuit integrated on a μTAS chip, in addition to a flow passage or a pump for the sake of chemical reaction.

Many of conventionally proposed μTAS chips are flow type microchips which carry out stirring, mixing, reaction, sampling and the like while flowing a fluid on the chips. For example, a micro capillary electrophoresis chip which generates a high voltage gradient on a flow passage to move a fluid, which carries out preprocessing or separation, and which carries out non-contact conductivity measurement of a biological substance on a single substrate is known by “Micro Total Analysis Systems 2002, pages 491 to 493, ‘Separation and detection of organic scids in a CE microchip with contactless four-electrode conductivity detection’”. Since only a micro flow passage is formed on a capillary electrophoresis chip, a structure and fabrication of a chip itself are facilitated.

In addition, with respect to a microchip pileup type chemical reaction system, for example, Jpn. Pat. Appln. KOKAI Publication No. 2002-292275 discloses a chemical reaction system having a configuration in which there are laminated and integrated a predetermined number of microchips, each of which comprises a reaction material solution introducing section, a reaction product solution discharge section, and a micro channel serving as a reaction region communicating with these sections. Only a microchannel (micro flow passage) is formed on each chip of this system. The flow passage is designed so as to efficiently carry out a variety of reactions such as a chain-shaped reaction, a solvent sampling, an immunoreaction, an enzyme reaction, and an ion pair sampling reaction by utilizing an advantage such as a short molecule scattering distance or a large specific interface area which is a chemical reaction field. This chemical reaction system enables mass organic synthesis with high efficiency by laminating and integrating chips parallel to each other.

Further, with respect to a chemically integrated circuit and a method of manufacturing the circuit, Jpn. Pat. Appln. KOKAI Publication No. 2001-158000 discloses a chemical reaction circuit which is configured by forming a single functional chip in which a plurality of parts having the same function and the same mechanism are disposed in one chip by utilizing an optical molding technique, and by combining chips having different single functions with each other in a plurality of layers. In this publication, a single purpose type chemical IC having incorporated therein all functions required for one microchip has a problem in terms of general purpose property, quick responsiveness, and functional upgrading property. In contrast, the optical molding technique μTAS is suitable to high-mix low-volume production or individual production, and is superior in terms of manufacturing time and cost efficiency.

As a specific example, there is described a chemical integrated circuit in which there are laminated and coupled four chips consisting of: a first layer chip which is a “connector tube” having external and fluid input and output connectors; a second layer chip which is a “valve chip”; a third layer chip which is a “reactor chip”; and a fourth layer which is a “condensed chip”, making it possible to achieve one purpose.

Further, with respect to a flow control method in a microsystem, Jpn. Pat. Appln. KOKAI Publication No. 2002-163022 discloses a microsystem for introducing a sol-gel transiting substance with a stimulus into a fluid which flows in a micro flow passage of the microsystem, applying a stimulus to a desired site on the micro flow passage, and gelling the fluid, thereby controlling the flow. According to this system, it becomes possible to stop the flow of the fluid in the micro system or adjusting a flow rate or a flow speed without using a complicated valve structure on a microchip.

In the case of the capillary electrophoresis chip based on the technique described previously, the items of reaction and analysis which can be carried out on the chip are very limited. In addition, an electrode for generating a high voltage gradient in a flow passage is externally inserted into the flow passage, and comes into direct contact with the fluid. Thus, there are provided problems that an electrochemical reaction is prone to occur in the vicinity of the electrode, and that a biochemical substance is probe to be refined.

Moreover, in the case of the microchip in the microchip pileup type chemical reaction system as described in Jpn. Pat. Appln. KOKAI Publication No. 2002-292275, a configuration for carrying out a variety of reactions and samplings is provided by only a microchannel (micro flow passage). Therefore, a microchannel design (such as width, depth, and length) must be finely changed according to a fluid to be utilized or its purpose. Additionally, in the case of the microchip (flow passage) in such a microchip pileup type chemical reaction system, there are provided problems that there is a need for an external mechanism (pump) for transporting a fluid, and that quantitative fluid sampling cannot be carried out.

On the other hand, in the case of the chemical integrated circuit as described in Jpn. Pat. Appln. KOKAI Publication No. 2001-158000, a variety of microchips are molded in accordance with an optical molding technique. Accordingly, it is difficult to fabricate them as finely as parts such as in a semiconductor process with respect to a flow passage as well as parts such as valves or connectors, and thus, a variety of advantages in molecule scattering distance, specific interface area, and thermal capacity represented by a liquid layer microspace are reduced. In addition, since the optical molding technique requires a large amount of processing time as compared with a silicon process capable of mass-producing specific microcircuits, higher cost per chip is unavoidable.

In the microsystem utilizing sol-gel transition of a fluid as described in Jpn. Pat. Appln. KOKAI Publication No. 2002-163022, the composition of the fluid somewhat changes because a sol-gel transiting substance (in general, polymeric compound) is introduced into the fluid. This has affected a result of reaction, sampling, or analysis.

### BRIEF SUMMARY OF THE INVENTION

Therefore, it is an object of the present invention to provide an ultrasonic platform type microchip and a method of driving array-shaped ultrasonic transducers, wherein the microchip can be manufactured within a short manufacturing time and at a low cost while maintaining its general purpose usability, quick responsiveness, and functional upgrading property without changing a fluid composition and without degrading a variety of advantages represented by a liquid layer microspace.

A first feature of the present invention is an ultrasonic platform type microchip which is a flow type microchip for use in a micro chemical analysis system, configured to have a fine flow passage in which a fluid flows on a substrate, the microchip comprising:

a common platform composed of a transducer layer and a signal control circuit layer, the transducer layer having array-shaped ultrasonic transducers,

wherein the flow type microchip is configured on the common platform.

A second feature of the present invention is a method of driving array-shaped ultrasonic transducers configured beneath a flow type microchip configured to have a fine flow passage on a substrate, the method comprising:

selectively inputting a desired drive signal to the ultrasonic transducer such that a sound pressure in the flow passage increases from an input of the flow passage toward an outlet of the flow passage.

### BRIEF DESCRIPTION OF THE SEVERAL VIEWS OF THE DRAWING

FIG. 1 is a sectional view showing a first embodiment of the present invention and showing a basic configuration of an ultrasonic platform type micro chemical analysis system according to the invention.

FIG. 2 is a plan view of a transducer layer in FIG. 1.

FIG. 3 is a plan view showing an aspect of the ultrasonic platform type micro chemical analysis system, wherein transparent flow type microchips are laminated on the transducer layer.

FIG. 4 is a sectional view of the ultrasonic platform type micro chemical analysis system in FIG. 3.

FIG. 5 is a view illustrating an operation of a “pump” which is a first function of the first embodiment.

FIG. 6 is a view illustrating another operation of the “pump” which is the first function of the first embodiment.

FIG. 7 is a view illustrating an operation of the “pump” which is the first function of the first embodiment and showing an example in which ultrasonic transducers have been disposed immediately beneath a microchip flow passage along the flow passage.

FIG. 8 is a view illustrating an operation of the “pump” which is the first function of the first embodiment and showing an example in which ultrasonic transducers have been disposed immediately beneath a microchip flow passage along the flow passage.

FIG. 9 is a view illustrating an operation of the “pump” which is the first function of the first embodiment and showing an example in the case of using an ultrasonic transducer for generating a surface acoustic wave.

FIG. 10 is a view illustrating an operation of the “pump” which is the first function of the first embodiment and showing another example in the case of using the ultrasonic transducer for generating the surface acoustic wave.

FIG. 11 is a view illustrating an operation of a “valve” which is a second function of the first embodiment.

FIG. 12 is a view illustrating an operation of the “valve” which is the second function of the first embodiment.

FIG. 13 is a view illustrating an operation of the “valve” which is the second function of the first embodiment.

FIG. 14 is a view illustrating an operation of the “valve” which is the second function of the first embodiment and showing another configuration example.

FIG. 15 a view illustrating an operation of the “valve” which is the second function of the first embodiment and illustrating the configuration example of FIG. 14.

FIG. 16 is a view illustrating an operation of a “temperature gauge” which is a third function of the first embodiment.

FIG. 17 is a view illustrating an operation of the “temperature gauge” which is the third function of the first embodiment and showing a change state of a tone-burst wave.

FIG. 18 is a view illustrating an operation of the “temperature gauge” which is the third function of the first embodiment.

FIG. 19 is a characteristic view illustrating an operation of the “temperature gauge” which is the third function of the first embodiment, and showing flow velocity characteristic.

FIG. 20 is a view illustrating an operation of a “mixer” which is a fourth function of the first embodiment.

FIG. 21 is a view illustrating another example of the first embodiment and an operation of an optical absorption gauge using a photodiode.

FIG. 22 is a view illustrating another example of the first embodiment and an operation of an optical absorption gauge using a photodiode.

FIG. 23 is a view showing a still another configuration example according to the first embodiment.

FIG. 24 is a view showing a still another configuration example according to the first embodiment and showing a temperature characteristic.

FIG. 25 is a sectional view showing a modified example of the first embodiment.

FIG. 26 is a sectional view showing another modified example of the first embodiment.

FIG. 27 is a sectional view showing still another modified example of the first embodiment.

FIG. 28 is a view showing a second embodiment according to an ultrasonic platform type micro chemical analysis system of the present invention.

FIG. 29 is a view showing a third embodiment according to the ultrasonic platform type micro chemical analysis system of the present invention.

FIG. 30 is a view showing an example of a configuration of the ultrasonic platform type micro chemical analysis system of the third embodiment.

### DETAILED DESCRIPTION OF THE INVENTION

Hereinafter, embodiments of the present invention will be described with reference to the accompanying drawings.

In an ultrasonic platform type microchip according to the invention, a fluid is measured and controlled by means of an ultrasonic wave. The ultrasonic wave has features that: (1) even if a film or a plate exists, an ultrasonic wave can transmit the film or plate as long as acoustic matching is obtained; and (2) there can be excited a phenomenon caused by sound non-linearity even with a small amount of acoustic power by increasing a frequency.

Hereinafter, referring to the accompanying drawings, a detailed description will be given for an embodiment of an ultrasonic platform type micro chemical analysis system using the ultrasonic platform according to the invention.

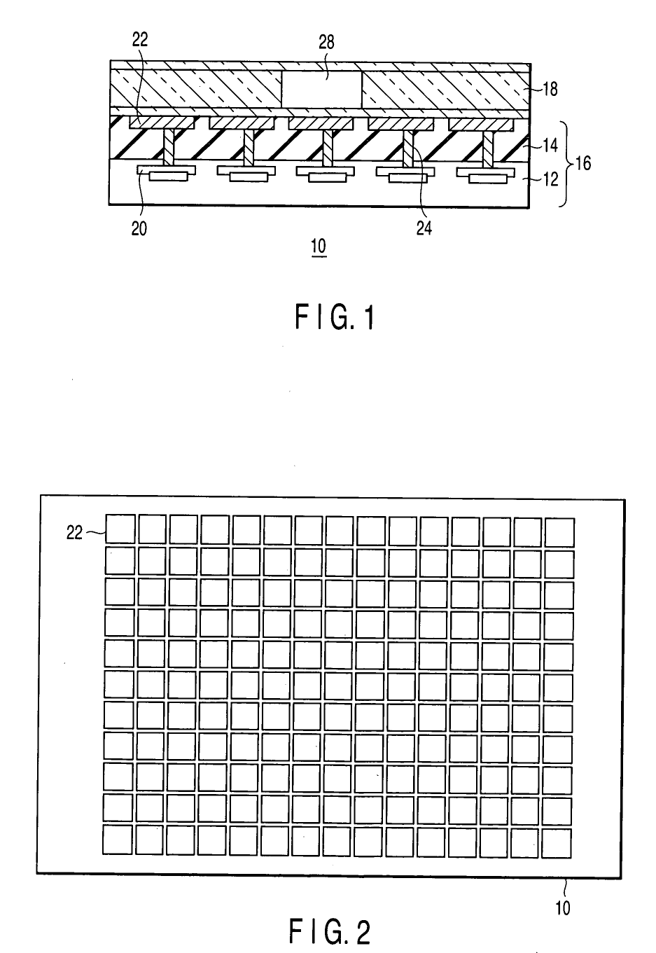

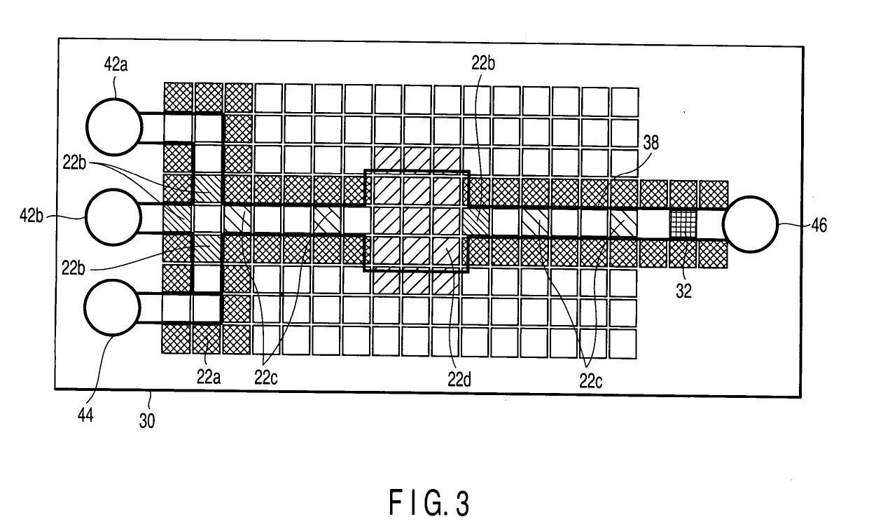

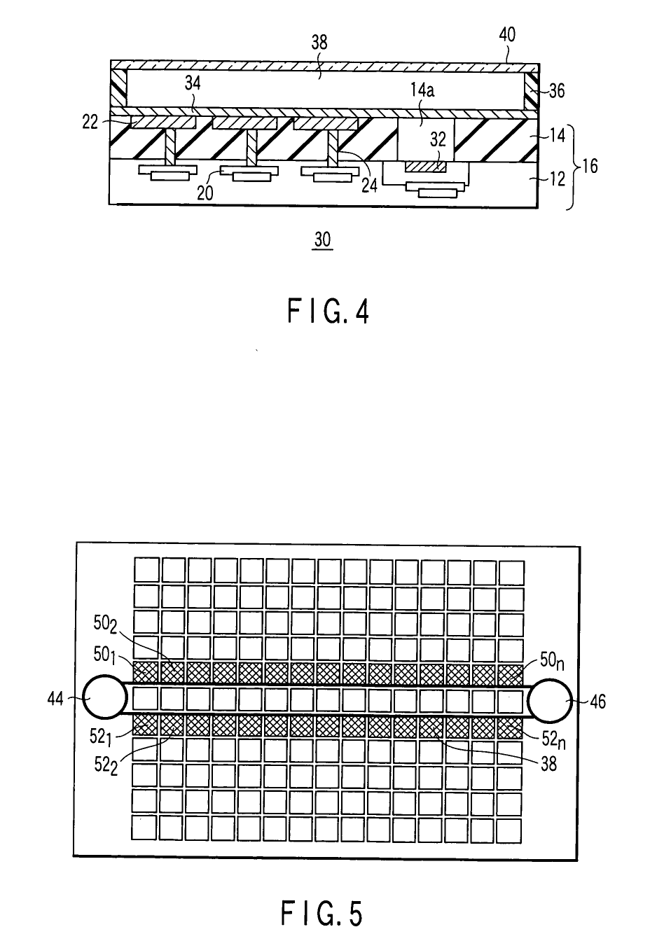

FIG. 1 is a sectional view showing a first embodiment of the present invention and showing a basic configuration of the ultrasonic platform type micro chemical analysis system according to the invention. FIG. 2 is a plan view of a transducer layer in FIG. 1. FIG. 3 is a plan view showing an aspect of the ultrasonic platform type micro chemical analysis system, wherein transparent flow type microchips are laminated on the transducer layer. FIG. 4 is a sectional view of the ultrasonic platform type micro chemical analysis system in FIG. 3.

In FIGS. 1 and 2, the first embodiment of the invention is configured as follows.

A basic ultrasonic platform type micro chemical analysis system 10 shown in FIG. 1 is configured to have: one common platform 16 having a signal control circuit layer 12 and a transducer 14; and a transparent flow type microchip 18 configured on the common platform 16.

The signal control circuit layer 12 has a plurality of processor circuits incorporated therein. The transducer layer 14 has a plurality of array-shaped ultrasonic transducers 22 disposed along a direction in which a fluid flows, as shown in FIG. 2. The ultrasonic transducer 22 can convert an input voltage to a vibration (ultrasonic wave) or can convert an inputted vibration to a voltage. In addition, the array-shaped ultrasonic transducer 22 is connected to the processor circuit 20 contained in a signal control circuit layer by wires 24, whereby conductivity of the transducer layer 14 is established. Consequently, the system 10 is configured so as to enable signal control such as driving or sensing relevant to a predetermined ultrasonic transducer. The common platform 16 can be configured in accordance with a semiconductor process.

The flow type microchip 18 is composed of a resin, a glass or the like. Then, a flow passage 28 according to its purpose is formed at the inside of the flow type microchip 18. The flow passage 28 is fixed onto a common platform after fabricated on a resin substrate apart from the common platform.

FIGS. 3 and 4 are views each showing an aspect of the ultrasonic platform type micro chemical analysis system in accordance with the first embodiment. This is a chemical analysis system which measures optical absorption having a predetermined wavelength while monitoring a fluid temperature after two reagents and one sample have been stirred and mixed quantitatively.

In addition to the basic configuration of the ultrasonic platform type micro chemical analysis system, the embodiment is configured to have a photodetector 32 in part of the signal control circuit layer 12 of the common platform 16. The common platform 16 is formed on a silicon substrate in accordance with a semiconductor process.

In addition, on the signal control circuit layer 12 in the common platform 16, a plurality of capacitive micromachined ultrasonic transducers (cMUT) disposed in a two-dimensional array shape are formed on the same substrate as a transducer layer 14.

A plurality of processor circuits 20 and a photodetector 32 are arranged in the signal control circuit layer 12. A plurality of array-shaped ultrasonic transducers 22 are provided in the transducer layer 14. The transducers 22 are connected to the processor circuits 20 by the wires 24.

In addition, a through hole 14a is formed at the upper part of a portion of the photodetector 33 in the transducer layer 14. The transducer layer 14 establishes conductivity with the signal control circuit layer 12 by the wires 24, and is configured to enable signal control of a predetermined cMUT.

Further, at the microchip side, an acoustic matching layer 34 composed of, for example, porous silicon made porous by anode chemical synthesis of silicon is provided on the transducer layer 14. A flow passage layer 36 and a flow passage 38 are formed on the acoustic matching layer 34. Moreover, a cover 40 is provided on the flow passage layer 36 and flow passage 38.

As shown in FIG. 3, in an ultrasonic platform type micro chemical analysis system 30 according to the embodiment, the flow passage 38 in the microchip is constructed at a position such that an arbitrary ultrasonic transducer 22 of the transducer layer 14 irradiates a fluid with an ultrasonic wave and generates a distribution of sound pressure strengths in a direction in which the fluid flows, thereby making it possible to achieve the following four functions.

A first function is a “pump” which moves a fluid along a flow passage, and a second function is a “valve” which controls a flow rate of the fluid. Further, a third function is a “temperature gauge” which detects a fluid temperature, and a fourth function is a “mixer” which stirs and mixes different types of fluids. All the four functions are achieved by selectively inputting a desired drive signal to the arbitrary ultrasonic transducer 22 in the transducer layer 14.

For example, in the ultrasonic platform type micro chemical analysis system 30 shown in FIG. 3, there are provided at the upstream side of the flow passage 38: a first reagent inlet (flow passage inlet) 42a and a second regent inlet 42b for use as reagent inlets; and a sample inlet 44 for use as a sample inlet. On the other hand, one outlet (flow passage outlet) 46 is provided at the downstream side of the flow passage 38.

From among the ultrasonic transducers 22 disposed in an array shape, a pump transducer 22a serving as the first function described previously is disposed along the flow passage 38. In addition, a mixing transducer 22d serving as the fourth function is disposed at the substantial center portion of the flow passage 38.

Moreover, valve transducers 22b each serving as the second function are disposed at the upstream side of a branch site of the flow passage 38 and at the downstream side of the mixing transducer 22d. Temperature gauge transducers 22c each serving as the third function are disposed at the downstream side of the branch site of the flow passage 38, at the upstream side and downstream side of the mixing transducer 22d, and at the upstream side of the outlet 46.

At the downstream side of the outlet, the photodetector 32 is provided beneath the flow passage 38.

Now, an operation of the first embodiment of the invention will be described here.

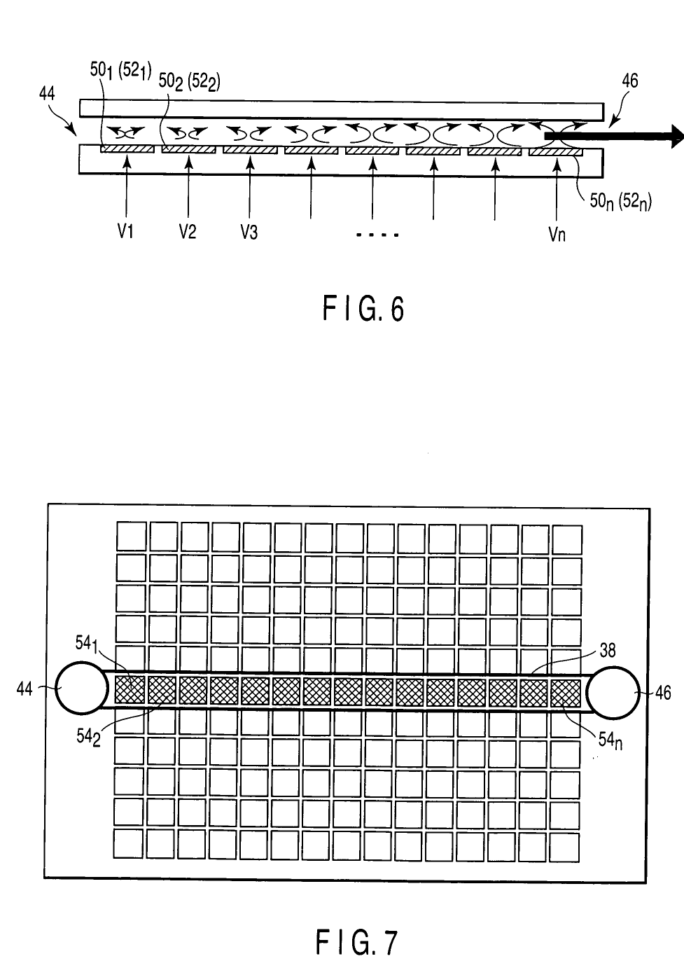

First, an operation of a “pump” which is the first function will be described with reference to FIGS. 5 and 6.

Here, for the sake of simplification, the ultrasonic platform type micro chemical analysis system, as shown in FIG. 5, is configured so that “n” ultrasonic transducers 50₁, 50₂, . . . , 50ₙ and 52₁, 52₂, . . . , 52ₙ have been disposed respectively at both of the outsides of the flow passage 38 having the inlet 44 and the outlet 46.

At the lower part of the microchip, the “n” ultrasonic transducers 50₁, 50₂, . . . , 50ₙ and 52₁, 52₂, . . . , 52ₙ disposed along both of the outsides of the flow passage 38 are driven at the same time at each of predetermined signals. At this time, a signal to be supplied to each of the ultrasonic transducers 50₁, 50₂, . . . , 50ₙ and 52₁, 52₂, . . . , 52ₙ is set so that drive voltages increase in sequence such that each radiation sound pressure has a relationship of the transducer 50₁ near the inlet 44 (52₁)<the transducer 50₂ (52₂)< . . . <the transducer 50ₙ (52ₙ) near the outlet 46. Each of the ultrasonic transducers 50₁, 50₂, . . . , 50ₙ and 52₁, 52₂, . . . , 52ₙ vibrates in response to a drive signal, and radiates an ultrasonic wave in a direction which is different from the direction in which the fluid flows.

As shown in FIG. 6, the ultrasonic wave radiated from each of the ultrasonic transducers generates an acoustic flow (straight flow) in a direction distant from a sound source in accordance with its non-linearity. At this time, the acoustic flow is bent in a direction in which the sound pressure is high, due to eccentricity (distribution) in balance of the sound pressure strength of the adjacent transducers. Thus, macroscopically, a flow field oriented from the inlet 44 to the outlet 46 is formed.

That is, at the lower part of the microchip, a voltage applied to at least one ultrasonic wave transmission means as described previously is made different from a voltage applied to the remaining ultrasonic carrying means by means of the “n” ultrasonic transducers disposed along both of the outsides of the flow passage. Alternatively, the function of “pump” which moves a fluid along a flow passage can be achieved by making the sound pressure strength near the at least one ultrasonic wave transmission means different from the sound pressure strength near the remaining ultrasonic wave transmission means.

In addition, such a “pump” function, as shown in FIG. 7, can be achieved by “n” ultrasonic transducers 54₁, 54₂, . . . , 54ₙ disposed along the flow passage 38 immediately beneath the microchip flow passage 38.

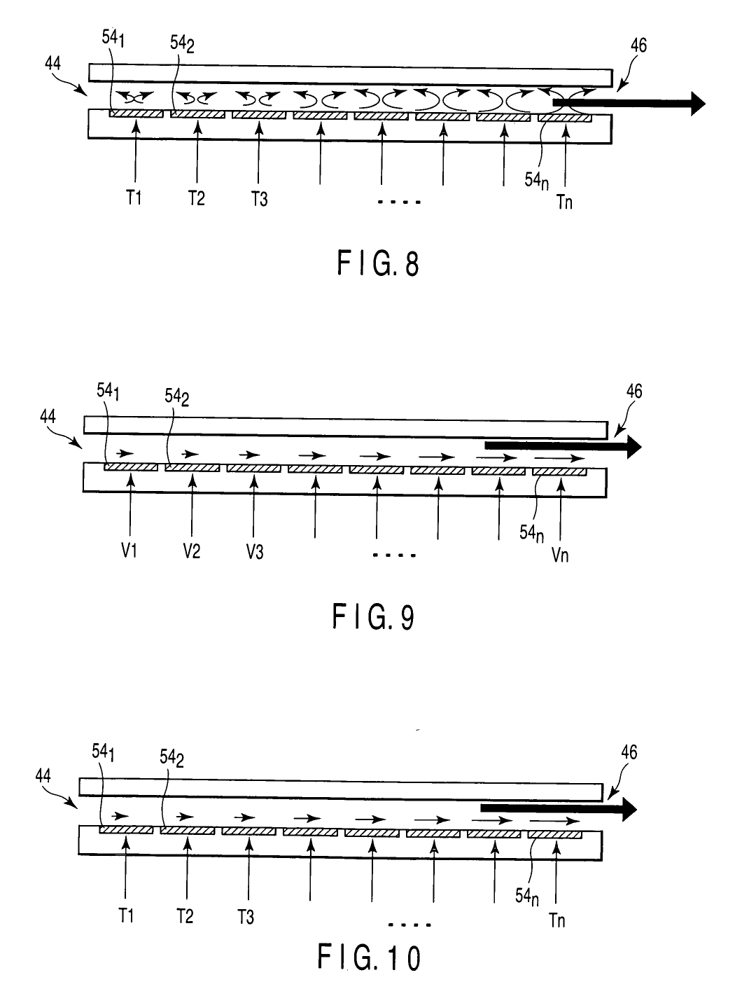

Further, the “n” ultrasonic transducers disposed along the flow passage are driven at the same time by means of each of predetermined signals. At this time, as shown in FIG. 8, drive signals are supplied to each of the ultrasonic transducers 54₁, 54₂, . . . , 54ₙ while sound wave radiation times are shifted, in sequence such that the radiation sound pressures have a relationship of the transducer 54₁ near the inlet 44<the transducer 54₂< . . . <the transducer 54ₙ near the outlet 46.

Although an acoustic flow (straight flow) is generated in a direction distant from a sound source by means of the ultrasonic wave radiated from each of the transducers, a sound field formed in a flow passage is changed with an elapse of time by shifting sound wave generation times of the adjacent transducers. Thus, the acoustic flow is bent in a direction in which a sound pressure is high at each time, and the flow field oriented from the inlet 44 to the outlet 46 can be formed on time average manner. That is, the function of “pump” can be achieved by means of time control as well.

Further, even in the case of using an ultrasonic transducer for generating a surface acoustic wave (SAW), the function of “pump” can be achieved, as shown in FIGS. 9 and 10, by setting a drive signal so that a vibration amplitude at a certain time increases in sequence such that the transducer 54₁ near the inlet 44<the transducer 54₂< . . . <the transducer 54ₙ near the outlet 46.

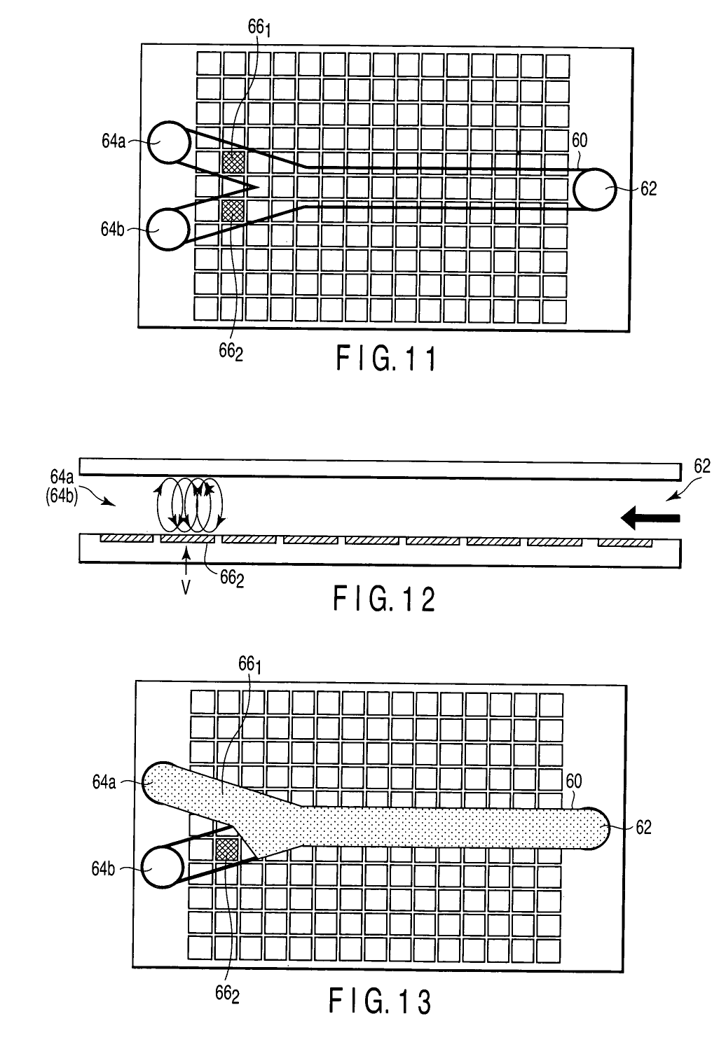

Now, an operation of the “valve” which is the second function will be described with reference to FIGS. 11 to 13.

As shown in FIG. 11, at a site at which a flow passage 60 of a flow type microchip branches, the ultrasonic transducers disposed respectively under the vicinity of the inlet of a branch flow passage are individually driven by a predetermined signal. At this time, a continuous wave set at a drive voltage whose frequency is at a sufficiently shorter wavelength than flow passage dimensions and is at a high radiation sound pressure is applied as a drive signal. The ultrasonic wave radiated from the ultrasonic transducer is a continuous wave whose frequency is at a sufficiently shorter wavelength than the flow passage dimensions. Thus, as shown in FIG. 12, an acoustic flow is generated in a bi-directional manner between an acoustic radiation surface and a flow passage wall opposed thereto. At the same time, since a high radiation sound pressure is obtained, this site becomes an obstacle to fluid movement.

For example, if a transducer 662 shown in FIG. 12 is driven as described previously, the fluid movement from the inlet 62 can be inhibited by the transducer 66₂. As a result, a switch valve for feeding a fluid from the inlet 62 to only an outlet 64a can be obtained as shown in FIG. 13. Further, an ultrasonic transducer disposed immediately beneath one flow passage is driven at a short wavelength and at a high radiation sound pressure, so that an on/off valve can be achieved.

A radiation sound pressure is changed by setting of a drive voltage value, thereby making it possible to achieve a valve which enables flow rate adjustment.

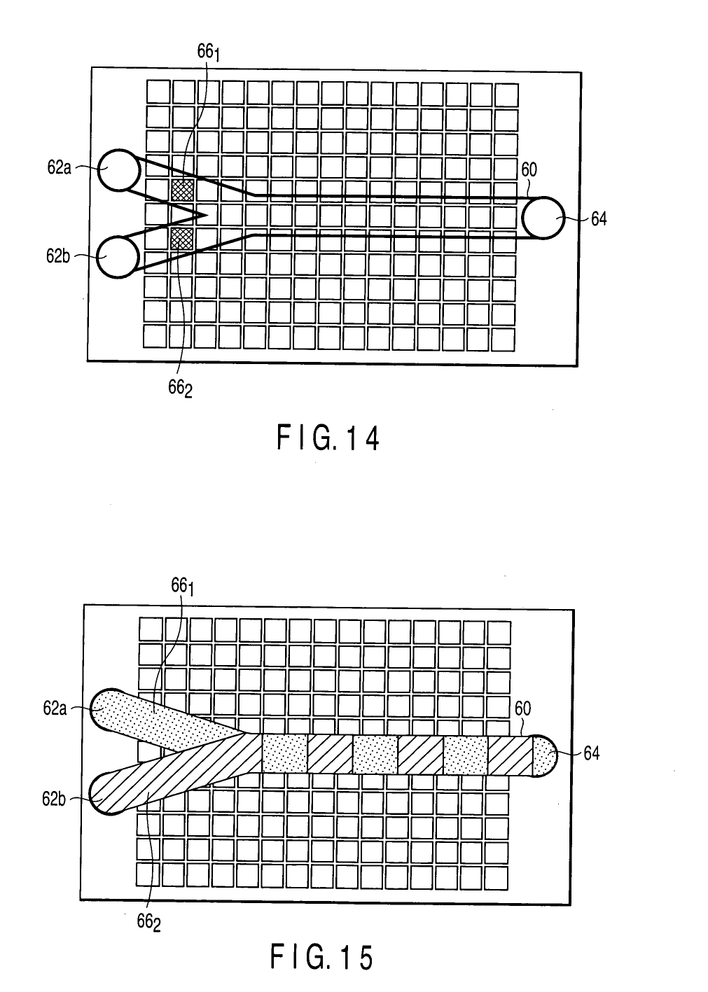

Moreover, as shown in FIG. 14, the present invention can be applied in the case of the flow passage 60 having the two inlets 62a and 62b and one outlet 64. That is, in the case where the fluid from the two inlets 62a and 62b is a microchip joining in the main flow passage 60, the valve transducers 66₁ and 66₂ are driven alternately for a predetermined time, thereby making it possible to quantify each fluid, as shown in FIG. 15.

As described above, by means of the ultrasonic transducer disposed immediately beneath the flow passage, a distribution of sound pressure strengths can be locally generated, so that it is possible to generate a resistance against the flow of the fluid at a portion at which the distribution occurs. In this manner, the function of “valve” capable of turning on/off the fluid and carrying out flow rate adjustment, quantification and the like can be achieved.

In the microchip which achieves the first or second function described previously, the transducers may be disposed at the upper part, at the lower part, at the left or right, or at one side or both sides of the flow passage as long as the distribution of desired sound pressure strengths can be generated in a direction in which the fluid flows, and its disposition and number are not limited.

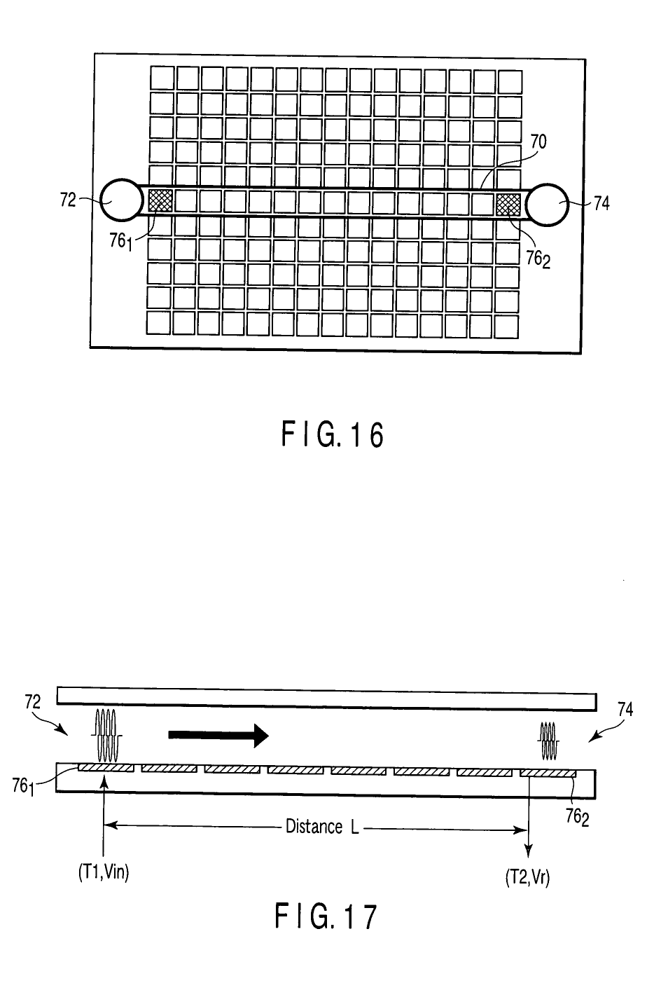

Now, an operation of the “temperature gauge” which is the third function will be described with reference to FIGS. 16 to 19.

In this case, immediately beneath a flow passage 70 having one inlet 72 and one outlet 74, a wave transmission ultrasonic transducer 76₁ serving as ultrasonic wave transmission means is disposed in the vicinity of the inlet 72, and a wave reception ultrasonic transducer 76₂ serving as ultrasonic wave reception means is disposed in the vicinity of the outlet 74.

The wave transmission ultrasonic transducer 76₁ provided at the lower part at the inlet 72 side of the flow passage 70 of the flow type microchip shown in FIG. 16 is driven by means of a tone burst wave. As shown in FIG. 17, the wave-transmitted tone burst wave is sent from the inlet 72 to the outlet 74 while the wave is attenuated. Then, the resulting wave is sensed by the wave reception ultrasonic transducer disposed to be spaced by a predetermined distance L, and the wave reception ultrasonic transducer outputs an output signal capable of discriminating that an ultrasonic wave has been received.

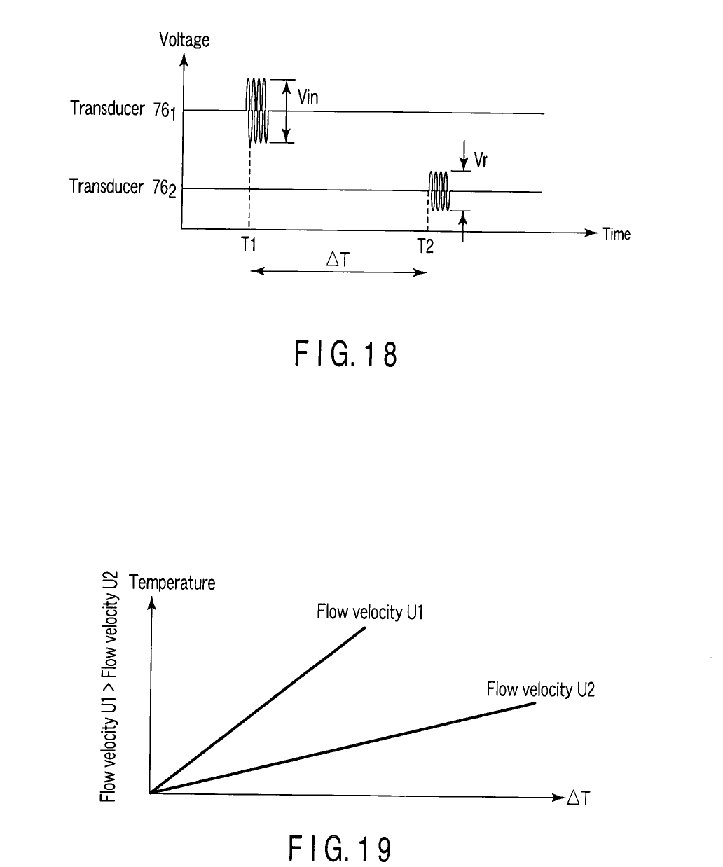

As shown in FIG. 18, when a time difference from wave transmission at the wave transmission ultrasonic transducer 76₁ to sound wave sensing by the wave reception ultrasonic transducer 76₂ is defined as ΔT, the following formula is generally established:
U+c(t)=L/ΔT (1)
wherein U is a flow velocity of a fluid, and “c” is a sound velocity of a fluid imparted by a function of a temperature “t”.

That is, if the distance L, the flow velocity U, and function of “c(t)” indicating a relationship between a temperature and a sound velocity of a fluid are known, the sound velocity value “c” obtained by Formula (1) above is inputted to the function of “c(t)”, whereby the temperature “t” can be obtained. Therefore, by using two ultrasonic transducers disposed under the flow passage at a predetermined distance, the foregoing processing is carried out by a signal processor circuit layer, thereby making it possible to achieve the function of “temperature gauge” for measuring a fluid temperature.

Even if a flow rate (Q) is defined instead of the flow velocity U, a similar result can be obtained.

Now, an operation of the “mixer” which is the fourth function will be described with reference to FIG. 20.

For example, in a flow passage 80 having two inlets 82a and 82b and one outlet 84, a liquid housing cell 86 which is greater than a flow passage width is provided on a flow passage of a microchip. In addition, a plurality of ultrasonic transducers 88_{(1, 1)}, 88_{(1, 2)}, . . . , 88_{(1, n)}, . . . , 88_{(m, 1)}, . . . , 88_{(m, n)} formed in a two-dimensional matrix shape are disposed under the liquid housing cell 86. Further, a valve transducer 90 for an optical absorption gauge is disposed at the downstream side of the plurality of two-dimensional matrix shaped ultrasonic transducers 88_{(1, 1)} to 88_{(m, n)}.

Now, assume that predetermined drive signals are supplied in irregular sequence to the plurality of ultrasonic transducers disposed in the two-dimensional matrix shape under the liquid housing cell. As has been explained as for the function of “pump” described previously, with respect to the ultrasonic wave radiated from each of the ultrasonic transducers, an acoustic flow (straight flow) is generated in a direction distant from a sound source in accordance with its non-linearity, but the acoustic flow is bent in a direction in which a sound pressure is high due to a balance in sound pressure strength of the adjacent transducers. Thus, the transducers each are driven in irregular sequence, whereby a distribution of sound pressure strengths is changed with an elapse of time. Then, at a portion at which the distribution changes, it is possible to form a respective different complicated flow field at each time, for example, a flow field in which there occurs a flow in a direction crossing an interface between fluids in a plurality of different physical properties or states, the fluids being introduced from the two inlets 82a and 82b, or there occur flows in directions opposed to each other in the fluids. Therefore, the “mixer” for stirring and mixing the liquid contained in the liquid housing cell can be achieved by optimally driving the ultrasonic transducers disposed in the two-dimensional matrix shape.

As shown in FIG. 20, the function of “valve” is added more downstream of the function of “mixer”, thereby making it possible to stir and mix the fluid to be stirred in the liquid housing cell in a state in which the fluid has been maintained.

While the first embodiment has described that stirring is carried out in a liquid housing cell capable of generating a more complicated flow, stirring may be carried out in a flow passage. If the distribution of the sound pressure strengths can be changed with an elapse of time, disposition of the ultrasonic transducers is not limited onto the two-dimensional matrix. In addition, it is not necessarily to move the transducers in irregular sequence, and a complicated flow may be generated by changing the sound pressure strength near the at least one ultrasonic wave transmission means and the sound pressure strength near the remaining ultrasonic wave transmission means.

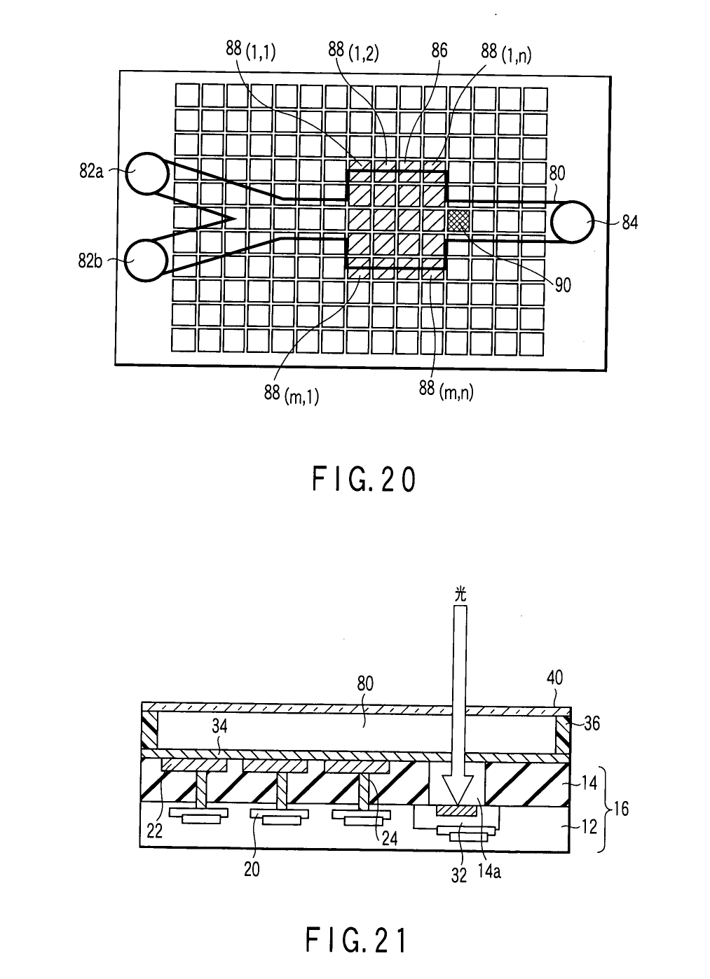

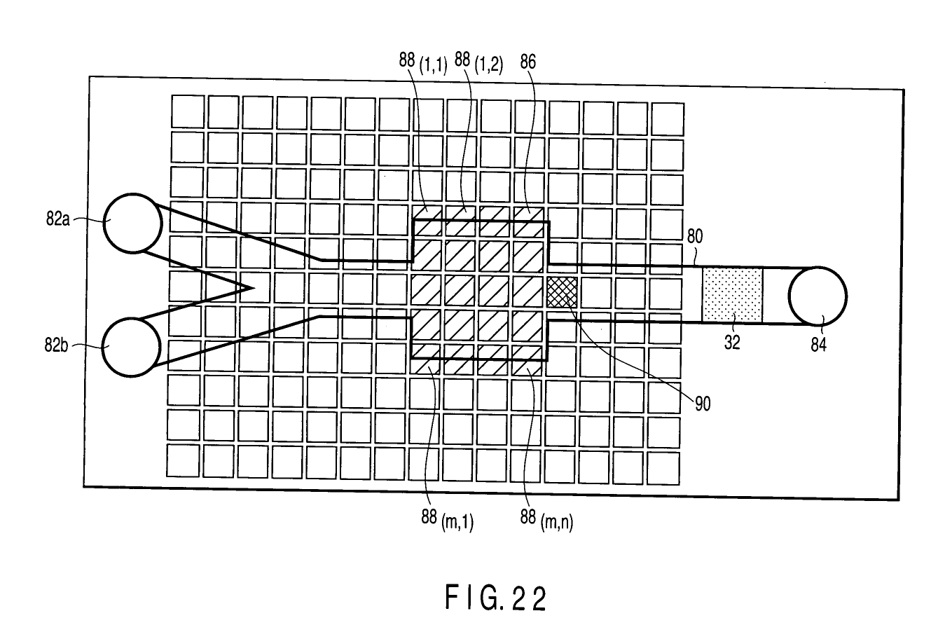

In the meantime, in the first embodiment, an optical absorption gauge is further configured at the downstream side of the function of “mixer”. Now, an operation of the optical absorption gauge using a photodiode will be described with reference to FIGS. 21 and 22.

Although not shown in FIG. 21, predetermined light is irradiated toward the microchip flow passage 80 from a light source installed to be distant upwardly of the flow type microchip flow passage. Then, the light having transmitted the microchip flow passage 80 is detected by the photodetector 32 provided in the signal control circuit layer 12.

With respect to a predetermined wavelength of the light detected by the photodetector 32, its light intensity is compared with that of an input light, whereby an absorption rate at the predetermined wavelength can be obtained in the signal control circuit layer 12.

In the above first embodiment, the fluid control step of quantifying, stirring, and mixing two reagents and one sample while monitoring a fluid temperature is achieved with only a combination of the arbitrary ultrasonic transducers in the transducer layer of the common platform, and optimal absorption measurement is achieved by the chemical analysis system utilizing the signal processing layer of the common platform.

An ultrasonic platform type micro chemical analysis system can be separately fabricated in accordance with each silicon process and resin processing with respect to the common platform and microchip. Thus, in this system, the standardized common platform can be manufactured in accordance with the silicon process while general purpose usability, quick responsiveness, and functional upgrading property required for the microchip are maintained without losing a variety of advantages represented by a liquid layer microspace, so that a short manufacturing time and low cost can be achieved. Further, there is no need for changing a fluid composition in the embodiment.

Further, in this system, there is no need for configuring a complicated fluid control element (such as a valve) on a microchip. Moreover, a function required for fluid control can be achieved merely by optimally controlling a frequency or amplitude, or alternatively, a irradiation time or irradiation time interval of an ultrasonic wave irradiated by signal control of the ultrasonic transducer in the common platform according to the purpose of the microchip.

Constituent elements according to the first embodiment, of course, can be variously modified or changed.

For example, the flow passage on the microchip can be properly changed according to its purpose. In addition, the number of fluid control elements is not limited to four shown in the embodiment, and many more fluid control elements may be achieved or one element may be achieved in one common platform.

In the microchip achieving the first or second function, transducers may be disposed at the upper part, at the lower part, at the right or left, at one side, or at both sides of a flow passage as long as a distribution of desired sound pressure strengths can be generated in a direction in which a fluid flow. The disposition of the transducers is not limited to a position immediately beneath the flow passage or both of the outside of the flow passage.

The signal control circuit formed in accordance with the semiconductor process may be CMOS, bipolar, a photodiode, by-CMOS or the like.

Further, the transducer layer and the signal control circuit layer in the common platform may be assembled by means of bonding, adhesive or the like while conductivity is established, after separately fabricated.

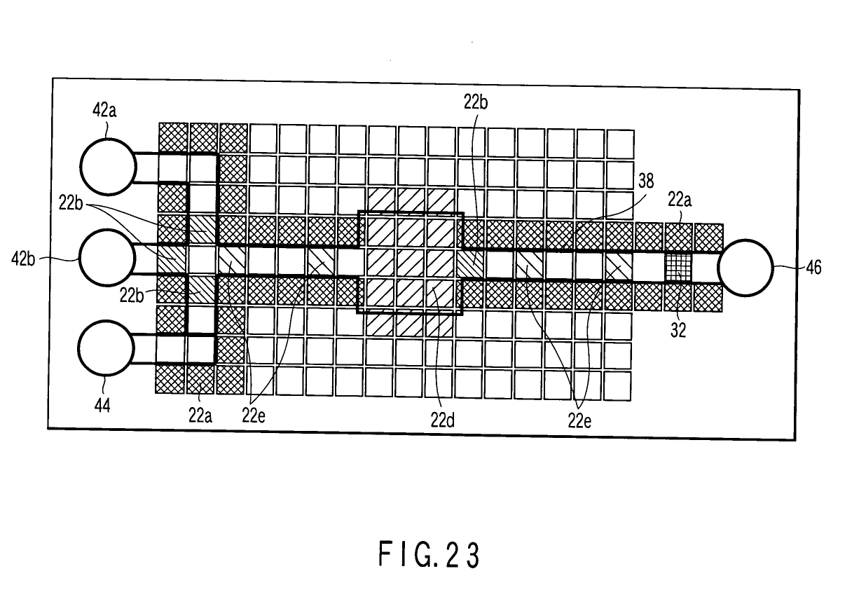

The system can be also configured such that the temperature gauge transducer 22c shown in FIG. 3 has been replaced with a flow velocity transducer 22e as shown in FIG. 23.

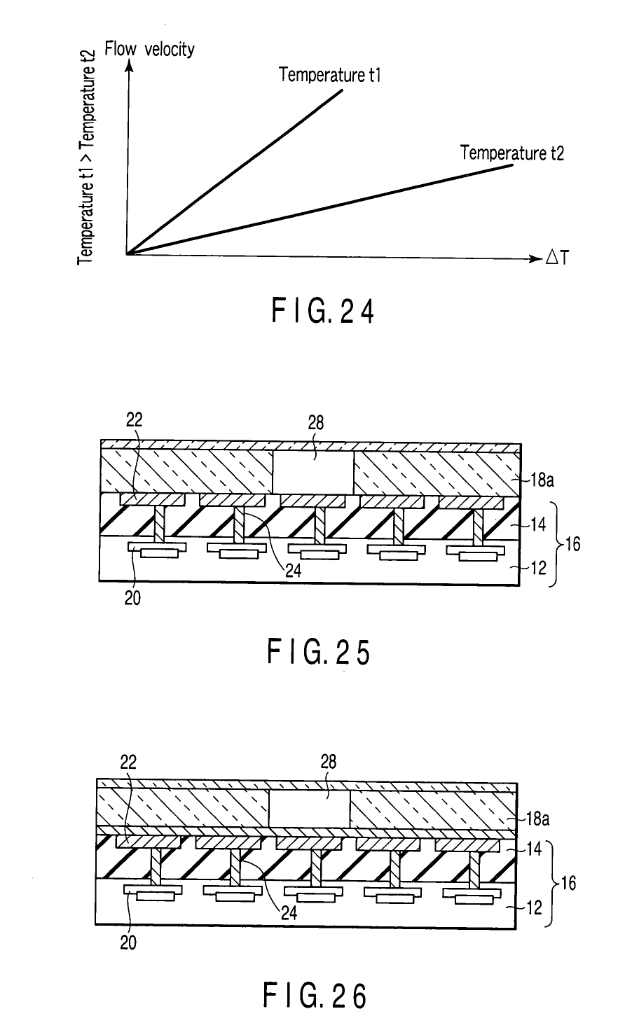

In more detail, if a distance L, a fluid type, and a temperature “t” are known by utilizing the fact that a sound velocity “c” is a sound velocity of a fluid imparted by a function of the temperature “t”, the sound velocity “c(t)” at that temperature can be obtained as shown in FIG. 24. The flow velocity U can be obtained from the foregoing formula (1). Therefore, by using two ultrasonic transducers disposed under a flow passage at a predetermined distance, the forgoing processing is carried out by the signal processor circuit layer, thereby making it possible to achieve the function of “flow velocity gauge” for measuring a flow velocity of a fluid.

A configuration may be provided so as to measure a frequency of an output signal, a difference in frequency between a drive (input) signal and an output signal or strength of an input or output signal according to the strength of ultrasonic wave, and a difference in strength between the drive signal and the output signal apart from a time difference from wave transmission to wave reception (sound wave sensing), i.e., a time difference between an inputted drive signal and an output signal from wave reception means. For example, it is possible to easily make control so as to obtain a desired sound pressure distribution by configuring a control system for measuring a signal according to the received ultrasonic wave and controlling an input signal based on the measured signal. Consequently, it becomes possible to make precise fluid control.

The foregoing ultrasonic transducer may be used as ultrasonic wave transmission and reception means compatible with ultrasonic wave transmission means and ultrasonic wave reception means. Further, a configuration may be provided so as to enable switching of functions serving as ultrasonic wave transmission means and a function serving as ultrasonic wave reception means according to time, purpose, and position.

The ultrasonic transducer may be a piezoelectric thick film or a piezoelectric thin film fabricated in accordance with an ejection deposition technique, a sol-gel synthesis technique, a water and heat synthesis technique, a sputtering technique, a print technique or the like without being limited to cMUT, and may be achieved by polishing a bulk-shaped piezoelectric material.

Further, as shown in FIG. 25, the transducer layer 14 may be configured so as to come into direct contact with a flow passage 28 of a flow type microchip 18a.

Furthermore, as shown in FIG. 26, a portion between the transducer layer 14 and the flow passage 28 of the flow type microchip 18a may be composed of an acoustic matched material (acoustic matched layer 34). The acoustic matched layer 34 may be porous silicon which is made porous due to anode synthesis of silicon, the flow type microchip itself may be composed of a resin which can be obtained as an acoustic matched layer, or an adhesive agent of fixing the flow type microchip 18a to the common platform 16 may be compatible with the acoustic matched layer.

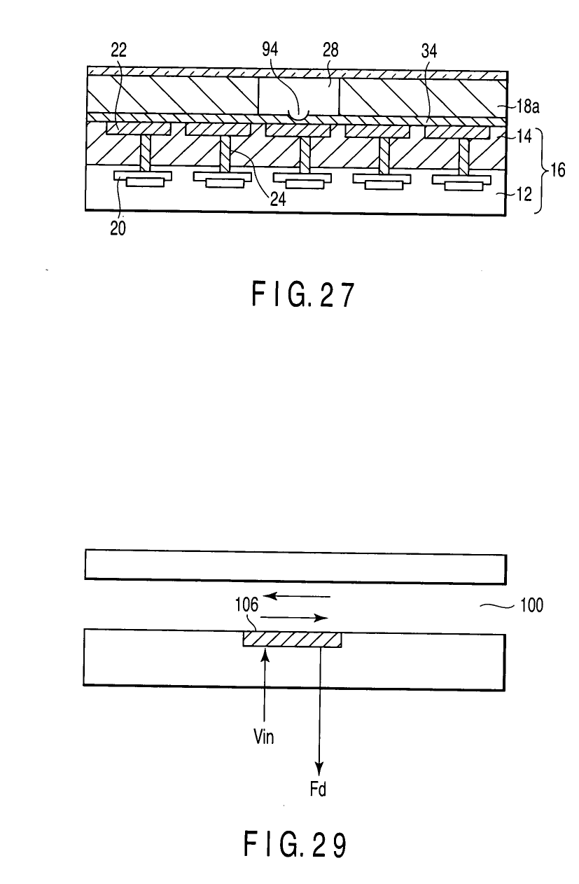

In addition, as shown in FIG. 27, an acoustic lens 94 may be provided between the transducer layer 14 and the flow passage 28 of the flow type microchip 18. In this manner, if the acoustic lens 94 is configured, it becomes possible to strengthen nonlinear effect of an ultrasonic wave at a predetermined position.

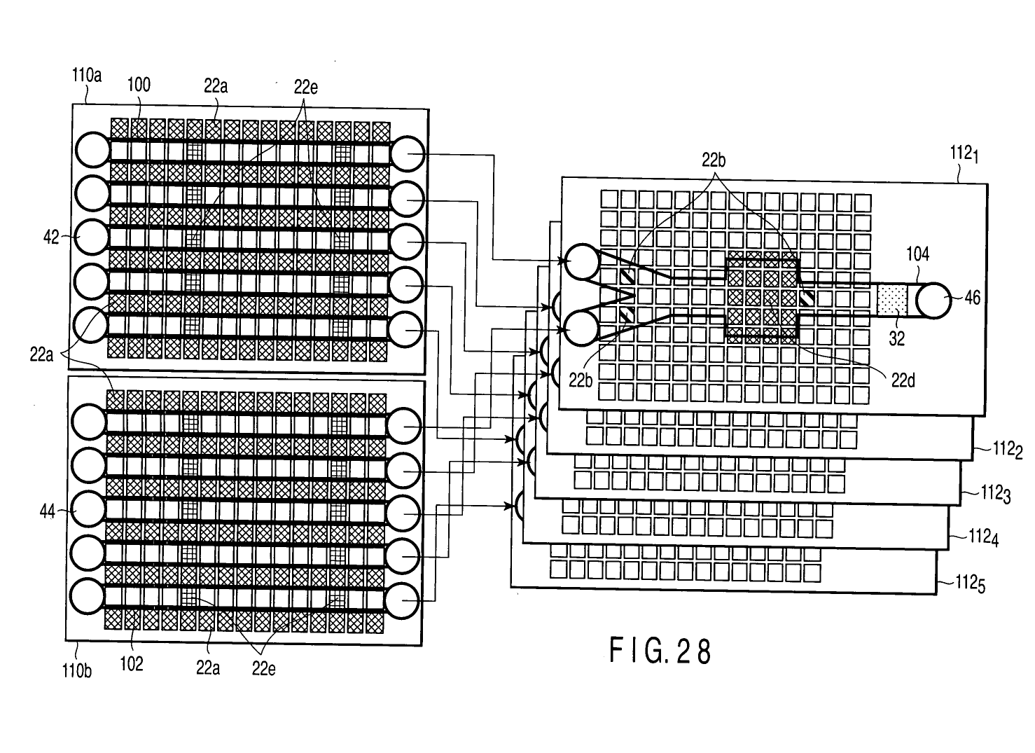

Now, a second embodiment according to an ultrasonic platform type micro chemical analysis system of the present invention will be described with reference to FIG. 28.

A basic configuration of a common platform and a flow type microchip in the second embodiment is identical to that of the ultrasonic platform type micro chemical analysis system according to the first embodiment described previously. However, this configuration achieves an object by arbitrarily combining a plurality of common platforms divided by the same type of fluid measurement control element.

In FIG. 28, a first common platform 110a is configured to have a plurality of flow passages 100 each having a reagent inlet 42, pump transducers 22a which correspond to the flow passages 100, and flow velocity gauge transducers 22e. Similarly, a second common platform 110b is configured to have a plurality of flow passages 102 each having a sample inlet 44, pump transducers 22a which correspond to the flow passages 102, and flow velocity gauge transducers 22e.

Third common platforms 112₁ to 112₅ each are configured to have: a flow passage 104 having an inlet for the first common platform 110a, an inlet for the second common platform 110b, and one outlet 46; valve transducers 22b, mixing (mixer) transducers 22d; and a photo detector 32.

The third common platforms 112₁ to 112₅ are prepared in number which corresponds to the number of the flow passages 100 and 102 of the first and second common platforms 110a and 110b. For example, as shown in FIG. 28, if the above flow passages 100 and 102 each are five in number in this microchip, a total of five platforms, i.e., the third common platforms 112₁ to 112₅ each having the flow passage 104 which has two inlets are combined with each other for each flow passage.

In the second embodiment, the function of “pump”, the function of “flow velocity gauge”, the function of “mixer”, and the function of “valve” are incorporated. A variety of these functions bring about an operation and advantageous effect identical to those of the first embodiment described previously.

The second embodiment is effective in the case where a large amount of fluid has been processed in accordance with the same steps, and specifically, can be applied to a chemical synthesis pant or the like.

Constituent elements according to the second embodiment, of course, can be various modified and changed.

For example, the flow passage on the microchip can be properly changed according to its purpose. In addition, many more fluid control elements may be achieved without being limited to the four fluid control elements shown in the second embodiment.

Now, a function of “viscosity gauge” in a third embodiment according to the present invention will be described with reference to FIG. 29.

A basic configuration of a common platform and a flow type microchip in the third embodiment is identical to that of the ultrasonic platform type micro chemical analysis system according to the first embodiment described preciously, and is different therefrom in that an ultrasonic viscosity gauge is configured as a fluid control element.

The ultrasonic viscosity gauge according to the third embodiment is composed of: an transducer 106 (thick slide type or SAW type) which vibrates in parallel to a flow passage 100 of a flow type microchip; a resonator circuit including an ultrasonic transducer as one element of the resonator circuit, although not shown in FIG. 29; and a signal control circuit for detecting viscosity of a fluid from a frequency change of the resonator circuit.

Now, an operation of the third embodiment will be described here.

If, like a SAW, an ultrasonic device for generating a surface acoustic wave is vibrated in contact with a fluid, a load according to its viscosity is applied to the ultrasonic transducer, and thus, a nominal resonation frequency is lowered. On the other hand, the ultrasonic device has a direct current resistance component, a coil component, and a capacitance component like an equivalent circuit. Accordingly, a resonator circuit can be configured by combining it with another electrical element such as a capacitor.

Consequently, by monitoring an output of the resonator circuit, the lowering of the resonance frequency of the ultrasonic transducer can be acquired in real time.

In the third embodiment, the resonator circuit is provided as a circuit of the signal control circuit layer in the common platform (for example, the processor circuit 20 in FIG. 11). For this reason, it is possible to achieve the function of “viscosity gauge” as a fluid control element of the ultrasonic platform type micro chemical analysis system.

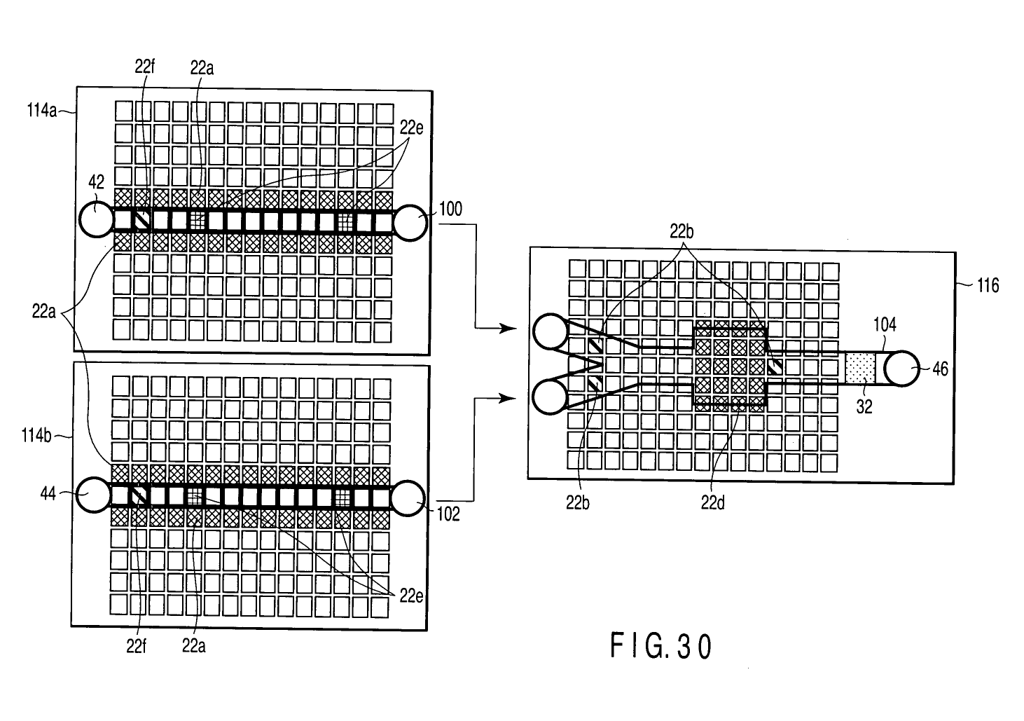

FIG. 30 is a view showing an example of a configuration of the ultrasonic platform type micro chemical analysis system according to the third embodiment.

In FIG. 30, a first common platform 114a is configured to have: a flow passage 100 having a reagent inlet 42; pump transducers 22a which correspond to the flow passage 100; flow velocity gauge transducers 22e; and a viscosity gauge transducer 22f. Similarly, a second common platform 114b is configured to have: a flow passage 102 having a sample inlet 44; pump transducers 22a which correspond to the flow passage 102; flow velocity gauge transducers 22e; and a viscosity gauge transducer 22f.

In addition, a third common platform 116 is configured to have: a flow passage 104 having an inlet for the first common platform 114a, an inlet for the second common platform 114b, and one outlet 46; valve transducers 22b; mixing (mixer) transducers 22d; and a photodetector 32.

Constituent elements according to the third embodiment, of course, can be modified and changed.

Now, a fourth embodiment according to an ultrasonic platform type micro chemical analysis system of the present invention will be described with reference to FIG. 1.

A basic configuration of the fourth embodiment is identical to that of the ultrasonic platform type micro chemical analysis system according to the first embodiment described previously. In this configuration, however, a transducer layer and a signal control circuit layer in a common platform each are fabricated on individual substrates, and these layers are assembled by adhesive or bonding in a state in which the conductivity of each layer has been established.

This configuration is effective in the case where the signal control circuit cannot be compatible with high temperature processing required for increasing processing precision of the transducer layer. For example, although high temperature durability of a CMOS circuit is in order of about 20° C. in general, there is a case in which a higher temperature is required for improving the fine processing precession of the ultrasonic transducer.

In this case, the transducer layer and the signal control circuit layer are fabricated on individual circuits, whereby it is possible to improve a substrate property of the transducer layer such as making it possible to finely generate the transducer without damaging the signal control circuit.

From the specific embodiments described previously, the inventions having the following configurations can be excerpted.

(1) A flow passage device comprising:

a flow passage in which a fluid flows; and

ultrasonic wave transmission means for irradiating an ultrasonic wave to the fluid contained in the flow passage in a direction which is different from a direction in which the fluid flows, and producing a distribution of sound pressure strengths in the direction in which the fluid flows.

(2) A flow passage device comprising:

a flow passage in which a fluid flows; and

a plurality of ultrasonic wave transmission means disposed along a direction in which the fluid flows so as to irradiate an ultrasonic wave to the fluid contained in the flow passage and to produce a distribution of sound pressure strengths in the direction.

(3) A flow passage device comprising:

a flow passage in which a fluid flows; and

ultrasonic wave transmission means disposed so as to irradiate an ultrasonic wave to the fluid contained in the flow passage in a direction which is different from a direction in which the fluid flows,

wherein the fluid is controlled by generating a distribution of sound pressure strengths of the ultrasonic wave in the direction in which the fluid flows.

(4) A fluid control apparatus set forth in the above item (3), wherein, by locally generating a distribution of the sound pressure strengths, a resistance against the flow of the fluid is generated at a portion at which the distribution occurs.

(5) A fluid control apparatus set forth in the above item (3), wherein a desired distribution of the sound pressure strengths is generated by controlling a frequency or an amplitude, or alternatively, an irradiation time or an irradiation time interval of the ultrasonic wave irradiated.

(6) A fluid control apparatus set forth in the above item (4), wherein a desired distribution of the sound pressure strengths is generated by controlling a frequency or an amplitude, or alternatively, an irradiation time or an irradiation time interval of the ultrasonic wave irradiated.

(7) A fluid control apparatus set forth in the above item (3), wherein the ultrasonic wave transmission means is ultrasonic wave transmission means for transmitting an ultrasonic wave in response to an inputted drive signal,

the apparatus further comprising ultrasonic wave reception means disposed to be spaced from the ultrasonic wave transmission means at a predetermined distance, the reception means receiving the transmitted ultrasonic wave to convert the received ultrasonic wave to an output signal.

(8) A fluid control apparatus set forth in the above item (7), wherein the ultrasonic wave reception means outputs an output signal capable of discriminating that an ultrasonic wave has been received.

(9) A fluid control apparatus set forth in the above item (7), wherein the ultrasonic wave reception means outputs an output signal in response to strength of the received ultrasonic wave.

(10) A fluid control apparatus set forth in the above item (7), wherein the ultrasonic wave reception means is compatible with ultrasonic wave transmission means.

(11) A fluid control apparatus set forth in the above item (3), wherein the ultrasonic wave reception means is an ultrasonic wave transducer which converts an electrical signal and an ultrasonic wave to each other, and

the ultrasonic wave transducer configures part of a resonator circuit and is capable of detecting a change of a resonance frequency of the resonator circuit.

(12) A fluid control apparatus comprising:

a flow passage in which a fluid flows; and

a plurality of ultrasonic wave transmission means for irradiating an ultrasonic wave to the fluid contained in the flow passage, the transmission means being disposed along a direction in which the fluid flows,

wherein the fluid is controlled by generating a distribution of sound pressure strengths of the ultrasonic wave in the direction in which the fluid flows.

(13) A fluid control apparatus set forth in the above item (12), wherein, by locally generating a distribution of the sound pressure strengths, a resistance against the flow of the fluid is generated at a portion at which the distribution occurs.

(14) A fluid control apparatus set forth in the above item (12), wherein sound pressure strength near at least one of the ultrasonic wave transmission means is different from sound pressure strength near the remaining ultrasonic wave transmission means.

(15) A fluid control apparatus set forth in the above item (12), wherein a distribution of the sound pressure strengths is changed with an elapse of time, thereby stirring the fluid at a portion at which the distribution changes.

(16) A fluid control apparatus set forth in the above item (12), wherein the fluid is composed of a plurality of different physical properties or states, and

the plurality of fluids are stirred by generating a distribution of the sound pressure strengths, and by generating a flow in a direction crossing an interface of the plurality of fluids in at least one fluid.

(17) A fluid control apparatus set forth in the above item (12), wherein a desired distribution of the sound pressure strengths is generated by controlling a frequency or an amplitude, or alternatively, an irradiation time or an irradiation time interval of the ultrasonic wave irradiated.

(18) A flow control apparatus set forth in any one of the above items (13) to (16), wherein a desired distribution of the sound pressure strengths is generated by controlling a frequency or an amplitude, or alternatively, an irradiation time or an irradiation time interval of the ultrasonic wave irradiated.

(19) A fluid control apparatus set forth in the above item (12), wherein a voltage applied to at least one of the ultrasonic wave transmission means is different from a voltage applied to the remaining ultrasonic wave transmission means.

(20) A fluid control apparatus set forth in the above item (12), wherein the ultrasonic wave transmission means is ultrasonic wave transmission means for transmitting an ultrasonic wave in response to an input drive signal,

the fluid control apparatus further comprising ultrasonic wave reception means disposed to be spaced from the ultrasonic wave transmission means at a predetermined distance, the reception means receiving the transmitted ultrasonic wave to convert the received wave to an output signal.

(21) A fluid control apparatus set forth in the above item (20), wherein the ultrasonic wave reception means outputs an output signal capable of discriminating that an ultrasonic wave has been received.

(22) A fluid control apparatus set forth in the above item (20), wherein the ultrasonic wave reception means outputs an output signal in response to strength of the received ultrasonic wave.

(23) A fluid control apparatus set forth in the above item (22), wherein the ultrasonic wave reception means is compatible with ultrasonic wave transmission means.

(24) A fluid control apparatus set forth in the above item (12), wherein the ultrasonic wave reception means is an ultrasonic wave transducer which converts an electrical signal and an ultrasonic wave to each other, and

the ultrasonic transducer configures part of a resonator circuit and is capable of detecting a change of a resonance frequency of the resonator circuit.

According to the present invention, there can be provided: an ultrasonic platform type microchip which can be manufactured within a short manufacturing time and at a low cost while maintaining general purpose usability, quick responsiveness, and functional upgrading property without changing a fluid composition and losing a variety of advantages represented by a liquid layer microspace; and a method of driving array-shaped ultrasonic transducers.

What is claimed is:

1. An ultrasonic platform type microchip which is a flow type microchip for use in a micro chemical analysis system, configured to have a fine flow passage in which a fluid flows on a substrate, the microchip comprising:
a common platform composed of a transducer layer and a signal control circuit layer, the transducer layer having array-shaped ultrasonic transducers,
wherein the flow type microchip is configured on the common platform.

2. An ultrasonic platform type microchip according to claim 1, wherein the transducer layer and the signal control circuit layer of the common platform are fabricated on one substrate in accordance with a semiconductor process.

3. An ultrasonic platform type microchip according to claim 1, wherein the transducer layer and the signal control circuit layer of the common platform each are produced on individual substrates, and then, are assembled by means of adhesive or bonding in a state in which conductivity of each layer has been established.

4. An ultrasonic platform type microchip according to claim 1, wherein the control circuit layer is composed of an electric circuit layer fabricated in accordance with a semiconductor process.

5. An ultrasonic platform type microchip according to claim 1, wherein the ultrasonic transducer is composed of a capacitive micromachined micro ultrasonic transducer.

6. An ultrasonic platform type microchip according to claim 1, wherein the ultrasonic transducer is composed of a transducer fabricated in accordance with an ejection deposition technique.

7. An ultrasonic platform type microchip according to claim 1, wherein the ultrasonic transducer is composed of a transducer fabricated in accordance with a sol-gel technique.

8. An ultrasonic platform type microchip according to claim 1, wherein the ultrasonic transducer is composed of a transducer fabricated in accordance with a water and heat synthesis technique.

9. An ultrasonic platform type microchip according to claim 1, wherein the ultrasonic transducer is composed of a transducer fabricated in accordance with a sputtering technique.

10. An ultrasonic platform type microchip according to claim 1, wherein the ultrasonic transducer is composed of a transducer fabricated in accordance with a printing technique.

11. An ultrasonic platform type microchip according to claim 1, wherein the ultrasonic transducer later is configured in direct contact with the flow passage of the flow type microchip.

12. An ultrasonic platform type microchip according to claim 1, wherein an acoustic matched layer is formed between the common platform and the flow passage of the direct flow type microchip.

13. An ultrasonic platform type microchip according to claim 12, wherein the acoustic matched layer is composed of porous silicon made porous by anode synthesis of silicon.

14. An ultrasonic platform type microchip according to claim 12, wherein the flow type microchip is composed of a resin which is obtained as an acoustic matched layer in itself.

15. An ultrasonic platform type microchip according to claim 12, wherein the flow type microchip has an acoustic lens provided in an acoustic matched layer of a site which comes into contact with the fluid contained therein.

16. An ultrasonic platform type microchip according to claim 1, wherein a drive signal is supplied to a plurality of ultrasonic transducers disposed along the flow passage of the flow type microchip such that a radiation sound pressure increases from an inlet of the flow passage toward an outlet of the flow passage, thereby generating a flow of a fluid oriented from the inlet of the flow passage to the outlet of the flow passage.

17. An ultrasonic platform type microchip according to claim 1, wherein a drive signal is supplied to a plurality of ultrasonic transducers disposed along the flow passage of the flow type microchip while sound wave radiation times are shifted from an input of the flow passage to an outlet of the flow passage, thereby generating a flow of a fluid oriented from the inlet of the flow passage toward the outlet of the flow passage.

18. An ultrasonic platform type microchip according to claim 1, wherein a drive signal, whose frequency is at a wavelength which is sufficiently shorter than flow passage dimensions and is obtained as a high radiation sound pressure, is supplied to an ultrasonic transducer disposed immediately beneath the flow passage of the flow type microchip, thereby controlling a flow rate in a predetermined flow passage.

19. An ultrasonic platform type microchip according to claim 1, the microchip having a liquid housing cell which is greater than a width of the flow passage in the flow type microchip, wherein a drive signal is supplied in irregular sequence to a plurality of ultrasonic transducers disposed at a lower part of the liquid housing cell in a two-dimensional matrix shape, thereby stirring and mixing the liquid contained in the liquid housing cell.

20. An ultrasonic platform type microchip according to claim 1, further comprising:
a wave transmission ultrasonic transducer provided at a flow passage inlet side of the flow type microchip;
a wave reception ultrasonic transducer disposed to be spaced from the wave transmission ultrasonic transducer to a flow passage outlet side at a predetermined distance;
an ultrasonic flow velocity gauge which obtains a flow velocity by measuring a time required for a tone burst wave wave-transmitted from the wave transmission ultrasonic transducer to be sensed by the wave receiving sound wave transducer.

21. An ultrasonic platform type microchip according to claim 1, further comprising:
a wave transmission ultrasonic transducer provided at a flow passage inlet side of the flow type microchip;
a wave reception ultrasonic transducer disposed to be spaced from the wave transmission ultrasonic transducer to a flow passage outlet side at a predetermined distance;
an ultrasonic temperature gauge which obtains a temperature by measuring a time required for a tone burst wave wave-transmitted from the wave transmission ultrasonic transducer to be sensed by the wave receiving sound wave transducer.

22. An ultrasonic platform type microchip according to claim 1, wherein the ultrasonic transducer is an ultrasonic transducer which vibrates parallel to the flow passage of the flow type microchip, and
the ultrasonic transducer configures part of a resonator circuit and detects viscosity of a fluid from a resonance frequency change of the resonator circuit.

23. An ultrasonic platform type microchip according to claim 1, wherein the flow type microchip is composed of a transparent material,
the signal control circuit layer has a photodetector at a potion thereof;
the transducer layer has a through hole above the photo detector, and
optical measurement is carried out with respect to light irradiated from a top surface of the flow passage of the flow type microchip on which the photodetector has been provided upwardly.

24. An ultrasonic platform type microchip according to claim 1, wherein the common platform is configured to have a plurality of fluid measurement control elements on one substrate.

25. An ultrasonic platform type microchip according to claim 1, wherein the common platform is configured to be divided every fluid measurement control element and to be arbitrarily combined.

26. A method of driving array-shaped ultrasonic transducers configured beneath a flow type microchip configured to have a fine flow passage on a substrate, the method comprising:
selectively inputting a desired drive signal to the ultrasonic transducer such that a sound pressure in the flow passage increases from an input of the flow passage toward an outlet of the flow passage.

27. A method of driving array-shaped ultrasonic transducers configured beneath a flow type microchip configured to have a fine flow passage on a substrate, the method comprising:
selectively inputting a desired drive signal to the ultrasonic transducer such that a sound pressure increases from an input of the flow passage toward an outlet of the flow passage by shifting ultrasonic radiation times of the ultrasonic transducers.

28. A method of driving array-shaped ultrasonic transducers configured beneath a flow type microchip configured to have a fine flow passage on a substrate, the method comprising:
selectively inputting a desired drive signal to the ultrasonic transducer such that a sound pressure locally increases between an inlet of the flow passage and an outlet of the flow passage.

29. A method of driving array-shaped ultrasonic transducers configured beneath a flow type microchip configured to have a fine flow passage on a substrate, the method comprising:
selectively inputting a desired drive signal to the ultrasonic transducer such that a plurality of fluids having different physical properties or states exist in the flow passage and that a flow is generate in a direction crossing an interface of said plurality of fluids.
